(19) United States
(12) Patent Application Publication
(10) Pub. No.: US 2025/0381852 A1
(43) Pub. Date: Dec. 18, 2025

(54) BATTERY ELECTRIC VEHICLE AND CONTROL METHOD

(71) Applicant: TOYOTA JIDOSHA KABUSHIKI KAISHA, Toyota-shi (JP)

(72) Inventors: Kentaroh KANZAKI, Toyota-shi (JP); Yoichiro ISAMI, Mishima-shi (JP); Tatsuya IMAMURA, Okazaki-shi (JP); Taro MOTEKI, Zama-shi (JP)

(73) Assignee: TOYOTA JIDOSHA KABUSHIKI KAISHA, Toyota-shi (JP)

(21) Appl. No.: 19/034,586

(22) Filed: Jan. 23, 2025

(30) Foreign Application Priority Data
Jun. 18, 2024 (JP) 2024-098248

(51) Int. Cl. B60L 15/20; B60L 3/12

(52) U.S. Cl. CPC B60L 15/20; B60L 3/12; B60L 2240/423; B60L 2240/486

(57) ABSTRACT

The present disclosure relates to battery electric vehicles including an electric motor as a driving source. Battery electric vehicle comprises one or more processors that control the electric motor to reproduce the behavior of the virtual vehicles that differ from battery electric vehicle. The one or more processors calculate the target torque based on the travel resistance of the virtual vehicle, and control the torque of the electric motor based on the target torque.

### CROSS-REFERENCE TO RELATED APPLICATION

This application claims priority to Japanese Patent Application No. 2024-098248 filed on Jun. 18, 2024, incorporated herein by reference in its entirety.

### BACKGROUND

### 1. Technical Field

The present disclosure relates to a battery electric vehicle that includes an electric motor as a driving source and a control method.

### 2. Description of Related Art

Japanese Unexamined Patent Application Publication No. 2022-030360 (JP 2022-030360 A) discloses a driving force control device for a vehicle including a motor as a driving force source. The driving force control device allows the vehicle to reproduce the driving force of a virtual vehicle having a power train different from that of the vehicle. The reproducible virtual vehicle includes a transmission vehicle.

### SUMMARY

There is known a battery electric vehicle in which an electric motor is used as a driving force source for travel, as disclosed in JP 2022-030360 A, and in which the driving force of a virtual vehicle is reproduced by controlling torque of the electric motor. In such a vehicle, if the driving feel of the virtual vehicle can be accurately reproduced, the degree of satisfaction of the driver can be further increased.

A first aspect of the present disclosure relates to a battery electric vehicle that includes an electric motor as a driving source. The battery electric vehicle includes one or more processors that control the electric motor so as to reproduce behavior of a virtual vehicle that is different from the battery electric vehicle. The one or more processors are configured to: calculate target torque based on a travel resistance of the virtual vehicle; and control torque of the electric motor based on the target torque.

A second aspect of the present disclosure relates to a control method of controlling a battery electric vehicle that includes an electric motor as a driving source. The control method includes: acquiring a travel resistance of a virtual vehicle that is different from the battery electric vehicle; calculating target torque for reproducing behavior of the virtual vehicle based on the travel resistance of the virtual vehicle; and controlling torque of the electric motor based on the target torque.

According to the first and second aspects of the present disclosure, the target torque based on the travel resistance of the virtual vehicle is calculated, and the torque of the electric motor is controlled based on the target torque. By using the traveling resistance of the virtual vehicle to calculate the target torque, it is possible to reproduce the drive feel of the different virtual vehicle according to the travel resistance, and it is possible to increase the degree of satisfaction of the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an exemplary configuration of a battery electric vehicle according to an embodiment of the present disclosure;

FIG. 2 is a tree diagram illustrating an exemplary selection input accepted by an HMI for a battery electric vehicle control mode;

FIG. 3 is a diagram illustrating an example of a functional configuration of a control device functioning as a motor control device;

FIG. 4 is a diagram illustrating an example of a functional configuration of an on-demand mode torque calculation unit;

FIG. 5 is a diagram illustrating an example of a method of calculating a target torque; and

FIG. 6 is a diagram illustrating an exemplary configuration of a battery electric vehicle including a pseudo-shifting operation member.

### DETAILED DESCRIPTION OF EMBODIMENTS

Embodiments of the present disclosure will be described with reference to the accompanying drawings.

### 1. Configuration of Battery Electric Vehicle Power System

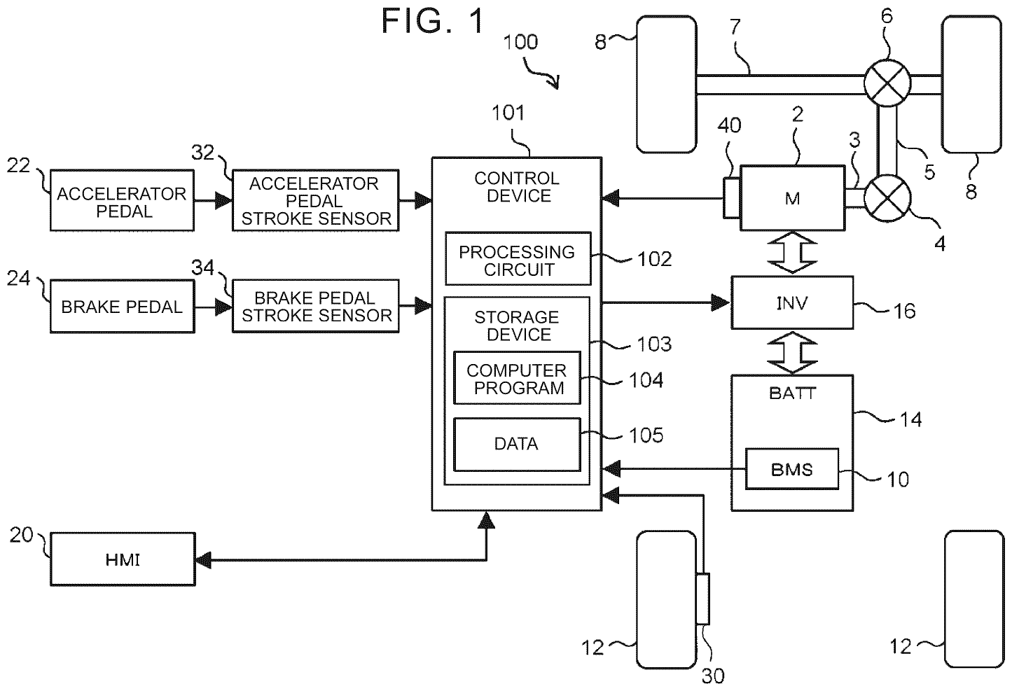

FIG. 1 is a diagram schematically illustrating a configuration of a battery electric vehicle 100 according to an embodiment of the present disclosure. First, referring to FIG. 1, a configuration of a power system of a battery electric vehicle 100 will be described.

Battery electric vehicle 100 includes an electric motor (M) 2 as a driving source for traveling. The electric motor 2 is, for example, a three-phase AC motor. An output shaft 3 of the electric motor 2 is connected to one end of a propeller shaft 5 via a gear mechanism 4. The other end of the propeller shaft 5 is connected to a drive shaft 7 in front of the vehicle via a differential gear 6.

Battery electric vehicle 100 comprises a drive wheel 8, which is a front wheel, and a dependent wheel 12, which is a rear wheel. The drive wheels 8 are respectively provided at both ends of the drive shaft 7.

Battery electric vehicle 100 includes a battery (BATT) 14 and inverter (INV) 16. The battery 14 stores electric energy for driving the electric motor 2. That is, battery electric vehicle 100 is a battery electric vehicle (BEV that runs on the electric power stored in the battery 14. The inverter 16 is, for example, a voltage type inverter. The inverter 16 controls the motor torque outputted from the electric motor 2 by PWM control.

### 2. Configuration of Battery Electric Vehicle Control System

Referring to FIG. 1, the configuration of the control system of battery electric vehicle 100 will be described.

Battery electric vehicle 100 includes a vehicle speed sensor 30 for detecting a vehicle speed. At least one wheel speed sensor (not shown) provided on each of the left and right front wheels 8 and the left and right rear wheels 12 is used as the vehicle speed sensor 30.

Battery electric vehicle 100 includes an accelerator pedal stroke sensor 32. The accelerator pedal stroke sensor 32 is provided on the accelerator pedal 22 and outputs a signal indicating an operation state of the accelerator pedal 22. The operating state of the accelerator pedal typically includes an accelerator operation amount and an accelerator opening speed. The accelerator pedal 22 is a pedal-type operation device operated by a foot. However, battery electric vehicle 100 may include a lever-type operation device or a dial-type operation device that is manually operated instead of the accelerator pedal 22 as the accelerator operation device.

Battery electric vehicle 100 also includes a brake pedal stroke sensor 34. The brake pedal stroke sensor 34 is provided on the brake pedal 24 and outputs a signal indicating an operation state of the brake pedal 24. The operating state of the brake pedal 24 typically includes a brake opening degree and a brake opening speed. The brake pedal 24 is a pedal-type operation device operated by a foot. However, battery electric vehicle 100 may include a lever-type operation device or a dial-type operation device that is manually operated instead of the brake pedal 24 as the brake operation device.

The accelerator pedal 22 and the brake pedal 24 are each one of the driving operation members used for driving battery electric vehicle 100. In addition, battery electric vehicle 100 may include various driving operation members such as steering wheels for driving related to steering.

Battery electric vehicle 100 includes a rotational speed sensor 40. The rotational speed sensor 40 is provided in the electric motor 2 and outputs a signal indicating the rotation speed of the electric motor 2.

Battery electric vehicle 100 comprises a battery management system (BMS) 10. The battery management system 10 is a device that monitors the cell voltage, current, temperature, and the like of the battery 14. The battery management system 10 has a function of estimating a state-of-charge (SOC) of the battery 14.

Battery electric vehicle 100 comprises a human machine interface (HMI) 20 as an interface to the driver. HMI 20 presents various types of information to the driver by displaying or sounding, and receives various types of input from the driver. HMI 20 includes a display (e.g., a multi-information display, a meter display), a switch, a touch pad, a speakerphone, a touch screen, and the like. For example, HMI 20 displays various types of information on the display and receives an input from the driver on the display content by operating the switch. Further, for example, HMI 20 displays various types of information on the touch screen, and receives an input from the driver on the display content by a touch operation on the touch screen.

Battery electric vehicle 100 includes a control device 101. Various sensors mounted on battery electric vehicle 100 and devices to be controlled are connected to the control device 101 by an in-vehicle network such as a controller area network (CAN). In addition to the vehicle speed sensor 30, the accelerator pedal stroke sensor 32, the brake pedal stroke sensor 34, and the rotational speed sensor 40, various sensors are mounted on battery electric vehicle 100. In addition to the vehicle speed sensor 30, the accelerator pedal stroke sensor 32, the brake pedal stroke sensor 34, and the rotational speed sensor 40, the control device 101 is connected via an in-vehicle network. For example, the sensor mounted on battery electric vehicle 100 may include a slope sensor that detects a slope of a road surface on which battery electric vehicle 100 is traveling.

The control device 101 generates control signals related to various types of control of battery electric vehicle 100 based on signals acquired from the respective sensors. The control device 101 is typically an electronic control unit (ECU). The control device 101 may be a combination of a plurality of ECU. The control device 101 includes at least a processing circuit 102 and a storage device 103.

The processing circuit 102 executes various kinds of processing. Processing circuitry 102 may comprise, for example, a general-purpose processor, an application-specific processor, a CPU (Central Processing Unit), GPU (Graphics Processing Unit), ASIC (Application Specific Integrated Circuit), FPGA (Field-Programmable Gate Array), integrated circuitry, conventional circuitry, and combinations of one or more thereof. A processor including transistors and other circuits is an example of the processing circuit 102. Processing circuitry 102 may also be referred to as a circuitry or a processing circuitry. Circuitry is hardware programmed to implement the functions described herein, or hardware executing the functions.

The storage device 103 stores various kinds of information necessary for executing the processing of the processing circuit 102. The storage device 103 is constituted by a recording medium such as RAM (Random Access Memory), ROM (Read Only Memory), SSD (Solid State Drive), HDD (Hard Disk Drive), and the like. The storage device 103 stores a computer program 104 executable by the processing circuit 102 and various types of data 105. The computer program 104 includes a plurality of instructions describing processing to be executed by the processing circuit 102. The computer program 104 may be recorded in a computer-readable recording medium. The functions of the control device 101 are realized by the cooperation of the processing circuit 102 for executing the computer program 104 and the storage device 103.

The control device 101 according to the present embodiment has at least two control modes, i.e., a normal mode and an on-demand mode, for controlling battery electric vehicle 100. The control of battery electric vehicle 100 executed by the control device 101 changes according to the selected control mode. The control mode of battery electric vehicle 100 will be described below.

### 3. Battery Electric Vehicle Control Mode

As described above, there are at least two control modes of battery electric vehicle 100: the normal mode and the on-demand mode. The normal mode is a control mode in which battery electric vehicle 100 is operated as a normal BEV. When the normal mode is selected, the control device 101 controls battery electric vehicle 100 so as to operate as a normal BEV. On the other hand, the on-demand mode is a control mode in which a vehicle behavior of a virtual vehicle (hereinafter referred to as “target virtual vehicle”) selected by a driver from among a plurality of virtual vehicles is reproduced by a battery electric vehicle 100. When the on-demand mode is selected, the control device 101 controls battery electric vehicle 100 so as to simulate the vehicle behavior of the target virtual vehicle.

The plurality of virtual vehicles that can be selected by the driver include various vehicles having different acceleration characteristics with respect to the driving operation of the driver. Each virtual vehicle may be assumed to be an actual vehicle or may be assumed to be a vehicle that does not actually exist.

The control mode is selected by the driver operating HMI 20. HMI 20 is configured to receive a control-mode selection from a driver. Further, HMI 20 is configured to receive a selection from a driver regarding the target virtual vehicle.

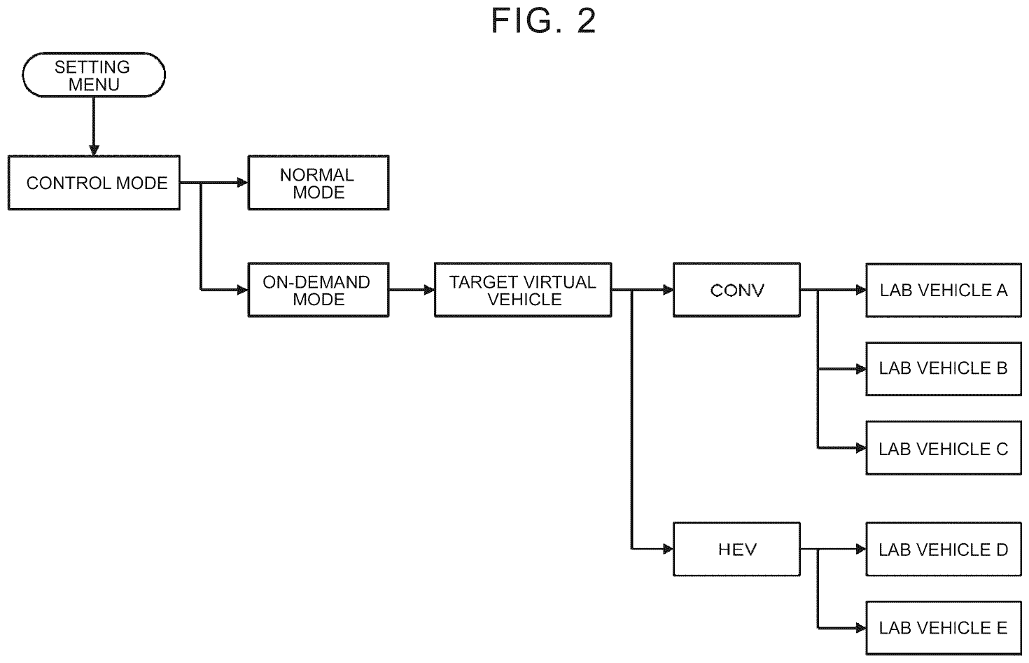

FIG. 2 is a tree diagram illustrating an exemplary selection input accepted by HMI 20. For example, HMI 20 receives a selection from the driver through a display or a touch screen according to the tree shown in FIG. 2 as follows.

First, HMI 20 displays a setting menu screen on a display or a touch screen according to a driver's manipulation. The option “control mode” is displayed on the initial screen of the setting menu screen. The option “control mode” is an option for accepting a selection input of the control mode from the driver.

When the option “control mode” is selected, the selection “normal mode” and the selection “on-demand mode” are displayed on the setting menu screen. When the option “normal mode” is selected, the control mode is switched to the normal mode, and control as a normal BEV is performed. On the other hand, when the option “on-demand mode” is selected, the control mode is switched to the on-demand mode.

In the on-demand mode, the driver can select the target virtual vehicles to be reproduced in battery electric vehicle 100. When the option “on-demand mode” is selected, next, the option “target virtual vehicle” is displayed on the setting menu screen. The option “target virtual vehicle” is an option for accepting a selection input of the target virtual vehicle from the driver.

When the option “target virtual vehicle” is selected, an option “CONV” and an option “HEV” are displayed on the setting menu screen. The choices “CONV” and “HEV” respectively indicate the categories of the plurality of virtual vehicles that can be selected in the on-demand mode. CONV is a class that shows a conventional internal combustion locomotive (conventional vehicle). HEV is a category indicating a hybrid vehicle (hybrid electric vehicle). When the option “CONV” is selected, the selection “virtual vehicle A”, the selection “virtual vehicle B”, and the selection “virtual vehicle C” are displayed on the setting menu screen. The virtual vehicle A, the virtual vehicle B, and the virtual vehicle C are virtual vehicles classified into CONV among a plurality of selectable virtual vehicles. Similarly, when the option “HEV” is selected, the options “virtual vehicle D” and “virtual vehicle E” are next displayed on the setting menu screen. The virtual vehicle D and the virtual vehicle E are virtual vehicles classified into HEV among a plurality of selectable virtual vehicles. When the driver selects any of these options, the corresponding virtual vehicle is set as the target virtual vehicle.

In the above description, the classification of the plurality of virtual vehicles is an example, and the options related to the classification may be changed as appropriate. For example, the categorization option may further include an option indicating plug-in hybrid electric vehicle (plugin hybrid electric vehicle) or fuel cell electric vehicle (fuel cell electric vehicle). Also, for example, the categorization option may include an option indicating a BEV. The categorization options may be capable of selecting a battery electric vehicle that differs from battery electric vehicle 100 as the target virtual vehicles. Further, for example, the classification option may indicate another classification such as a classification related to a type of an internal combustion engine (e.g., an inline-4 supercharged engine, a flat-6 engine, or a V-12 engine) to be mounted. Alternatively, when the option “on-demand mode” is selected, the option related to the virtual vehicle may be displayed without displaying the option related to the classification.

Further, for each option, the name displayed on the setting menu screen may be appropriately set in consideration of ease of understanding by the driver. For example, in the option related to the virtual vehicle, the displayed name may be a more specific one in which the driver, such as a vehicle type or a product name, easily images the virtual vehicle.

As described above, the driver can select the control mode by operating HMI 20. The control device 101 controls battery electric vehicle 100 according to the selected control mode.

The control device 101 according to the present embodiment functions as a motor control device that controls the electric motor 2 in response to at least a driver's driving manipulation with respect to the control of battery electric vehicle 100. Specifically, when the processing circuit 102 executes the electric motor control computer program 104 stored in the storage device 103, the control device 101 functions as a motor control device. Hereinafter, the control of battery electric vehicle 100 by the motor control device will be described.

### 4. Motor Control Equipment

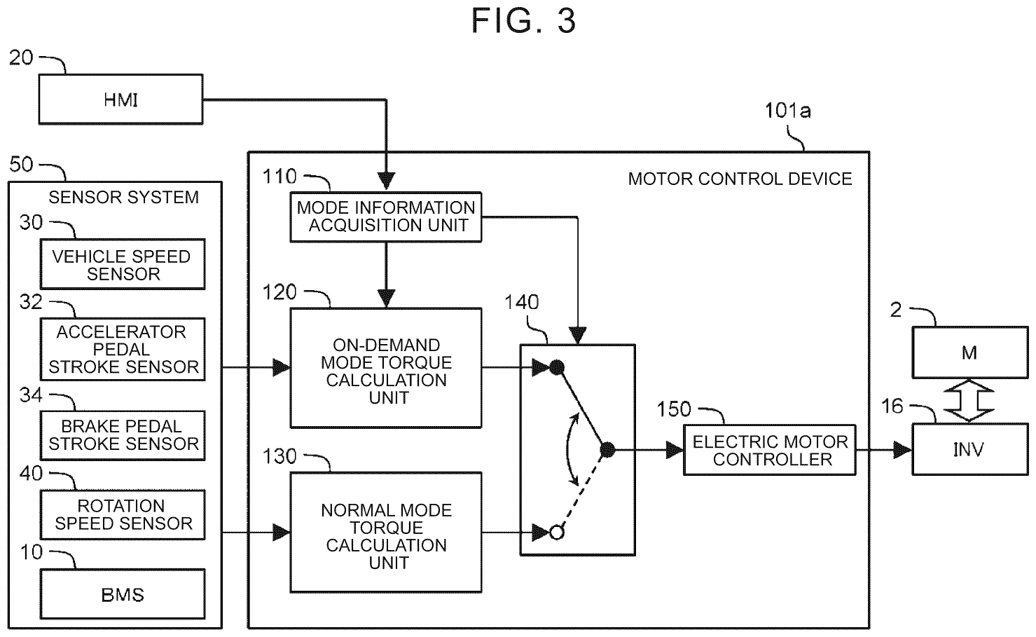

FIG. 3 is a diagram illustrating an exemplary functional configuration of the motor control device 101a. The motor control device 101a calculates a target torque of the drive wheels according to the driver's driving operation. The motor control device 101a then controls the electric motor 2 via the inverter 16 to generate the calculated target torques on the drive wheels.

An HMI 20 and a signal from the sensor system 50 are inputted to the motor control device 101a. The sensor system 50 includes a vehicle speed sensor 30, an accelerator pedal stroke sensor 32, a brake pedal stroke sensor 34, a rotational speed sensor 40, and a battery management system 10. The sensor system 50 may include other sensors (not shown). For example, the sensor system 50 may include a steering angle sensor, a yaw rate sensor, a IMU (Inertial Measurement Unit, a gradient sensor, a sensor (e.g., a camera, a radar, a LiDAR) for detecting an ambient environment of battery electric vehicle 100, and the like. The steering angle sensor detects a steering angle of the steering wheel. The yaw rate sensor detects a yaw rate of battery electric vehicle 100. IMU detects the pose of battery electric vehicle 100. The slope sensor detects a slope of the road surface.

The signal inputted from HMI 20 to the motor control device 101a includes a signal indicating a control mode selected by the driver and a signal indicating a target virtual vehicle selected by the driver. The signal inputted from the sensor system 50 to the motor control device 101a includes a signal indicating the vehicle speed of battery electric vehicle 100 and a signal indicating the operating condition of the accelerator pedal 22. Further, the signal inputted from the sensor system 50 to the motor control device 101a includes a signal indicating the operating state of the brake pedal 24, a signal indicating the rotational speed of the electric motor 2, and a signal indicating the state (e.g., cell voltage, current, temperature, SOC) of the battery 14.

The motor control device 101a includes, as functional blocks, a mode information acquisition unit 110, an on-demand mode torque calculation unit 120, a normal mode torque calculation unit 130, a target torque switching unit 140, and an electric motor control unit 150. These functional blocks are realized by the cooperation of the processing circuit 102 which executes the computer program 104 and the storage device 103.

The mode information acquisition unit 110 receives a signal from HMI 20 and acquires information on which of the normal mode and the on-demand mode is selected. When the on-demand mode is selected, the mode information acquisition unit 110 acquires information on the target virtual vehicle. Then, the mode information acquisition unit 110 transmits the information of the selected control mode to the target torque switching unit 140, and transmits the information of the selected target virtual vehicle to the on-demand mode torque calculation unit 120.

The on-demand mode torque calculation unit 120 that has acquired the information of the target virtual vehicle calculates the target torque based on the signal from the sensor system 50. This is to reproduce the behavior of the target virtual vehicles in battery electric vehicle 100 in accordance with the driver's driving maneuver.

The normal-mode torque calculation unit 130 calculates a target torque for operating battery electric vehicle 100 as a normal BEV based on a signal from the sensor system 50. Specifically, the normal mode torque calculation unit 130 calculates the target torque using a map in which the accelerator operation amount of the accelerator pedal 22 and the rotation speed of the electric motor 2 are used as parameters. In addition, the brake opening degree of the brake pedal 24 and SOC of the battery 14 may be used as parameters for calculating the target torque in the normal-mode torque calculation unit 130. However, in the present embodiment, the processing executed by the normal mode torque calculation unit 130 is not particularly limited. Other suitable known techniques may be applied to the processing executed by the normal mode torque calculation unit 130.

The on-demand mode torque calculation unit 120 calculates a target torque for reproducing the behavior of the target virtual vehicles in battery electric vehicle 100 on the basis of a signal from the sensor system 50. Details of the processing in the on-demand mode torque calculation unit 120 will be described later.

The target torque switching unit 140 switches the target torque for controlling the electric motor 2 in accordance with the selected control mode. The target torque switching unit 140 acquires information on the control mode selected from the mode information acquisition unit 110. When the on-demand mode is selected, the target torque switching unit 140 transmits the target torque calculated by the on-demand mode torque calculation unit 120 to the electric motor control unit 150. When the normal mode is selected, the target torque switching unit 140 transmits the target torque calculated by the normal mode torque calculation unit 130 to the electric motor control unit 150.

When the on-demand mode is selected, the normal mode torque calculation unit 130 may be configured not to execute processing. Similarly, when the normal mode is selected, the on-demand mode torque calculation unit 120 may be configured not to execute the processing.

The target torque calculated by the on-demand mode torque calculation unit 120 or the normal mode torque calculation unit 130 is input to the electric motor control unit 150 via the target torque switching unit 140. The electric motor control unit 150 changes the motor torque of the electric motor 2 so that the drive wheel torque becomes the target torque. More specifically, the electric motor control unit 150 generates a control signal for the inverter 16 in accordance with the input target torque. Then, the electric motor control unit 150 changes the motor torque outputted from the electric motor 2 via PWM control by the inverter 16.

In this manner, the motor control device 101a controls the electric motor 2 in accordance with the target torque according to the control mode. By such control of the motor control device 101a, the acceleration characteristics of battery electric vehicle 100 when the on-demand mode is selected simulate the acceleration characteristics of the target virtual vehicles. By such control of the motor control device 101a, the acceleration characteristic of battery electric vehicle 100 when the normal mode is selected becomes the acceleration characteristic of the normal BEV.

### 5. Calculation of Target Torque in On-Demand Mode

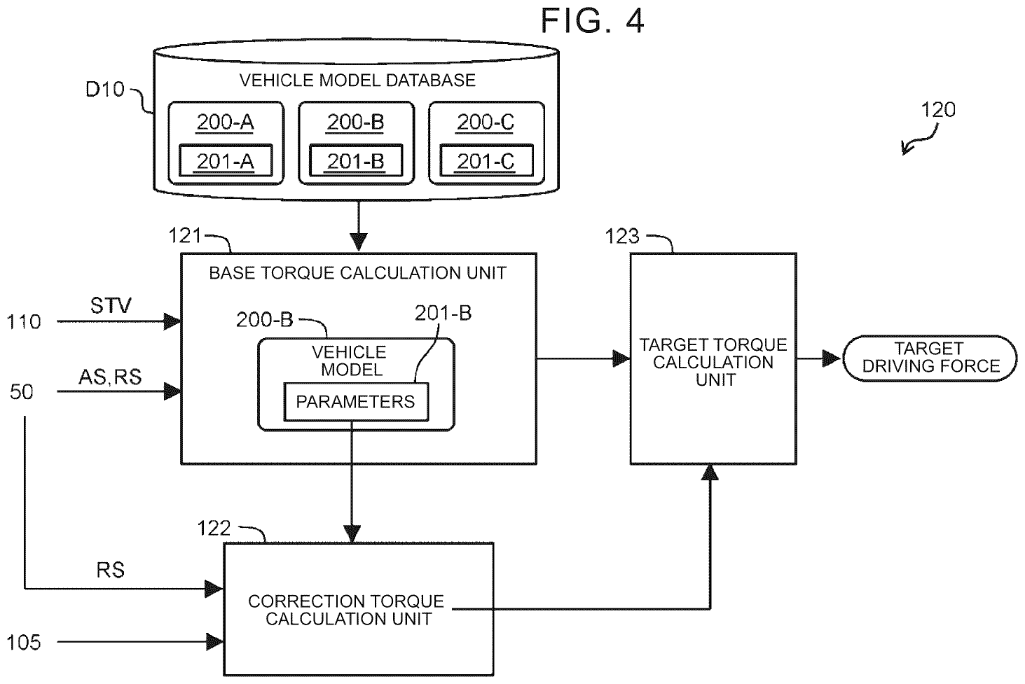

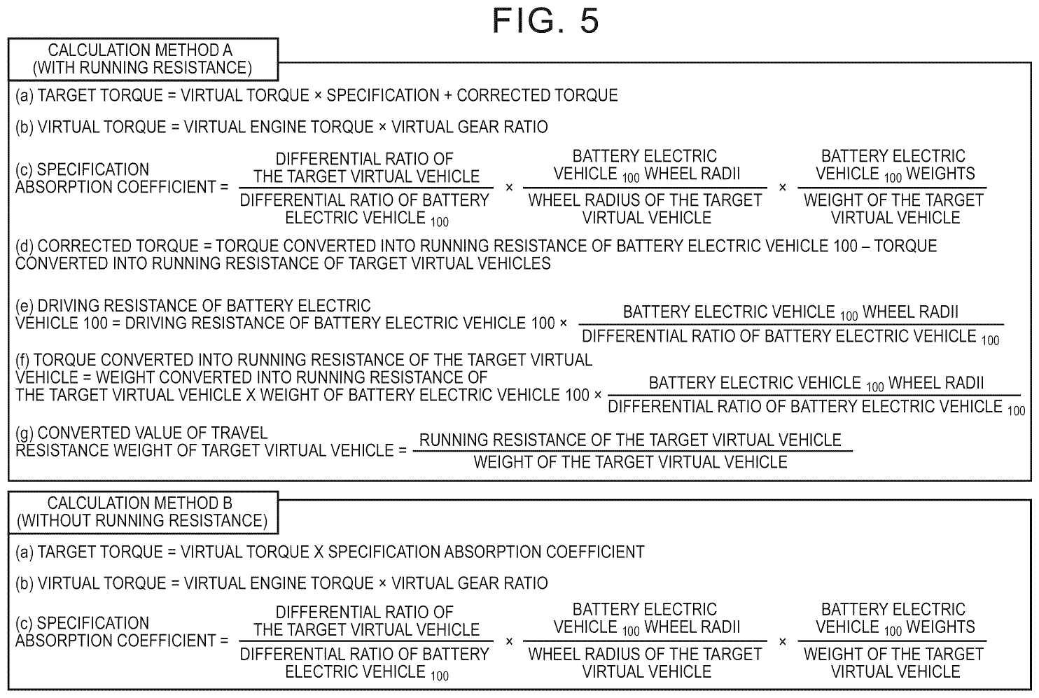

The on-demand mode torque calculation unit 120 calculates the target torque so as to reproduce the acceleration property of the target virtual vehicles with respect to the driving manipulation of the driver by battery electric vehicle 100. As a result, the acceleration characteristic of battery electric vehicle 100 when the on-demand mode is selected changes to various patterns corresponding to the target virtual vehicle as the target virtual vehicle is changed. The driver can enjoy the driving feeling of various virtual vehicles in the on-demand mode. Hereinafter, a method of calculating the target torque in the on-demand mode will be described with reference to FIGS. 4 and 5.

FIG. 4 is a diagram illustrating an example of a functional configuration of the on-demand mode torque calculation unit 120. FIG. 5 shows an example of a calculation method when the target torque calculated by the functional configuration of FIG. 4 is expressed by a calculation formula. The calculation method A in which the traveling resistance is taken into consideration is the calculation method in the present embodiment. For comparison, FIG. 5 shows a calculation method of the target torque when the traveling resistance is not taken into consideration as the calculation method B.

The on-demand mode torque calculation unit 120 includes a base torque calculation unit 121, a correction torque calculation unit 122, and a target torque calculation unit 123 as functional blocks. The on-demand mode torque calculation unit 120 is configured to be accessible to the vehicle model database D10.

The vehicle model database D10 is a database for managing a plurality of vehicle models 200 modeled on a plurality of virtual vehicles. The vehicle model database D10 is implemented as data 105 stored in the storage device 103. In addition, a new vehicle model 200 may be downloaded to the vehicle model database D10 at any time. In the embodiment shown in FIG. 4, the vehicle model database D10 manages three vehicle models 200-A, 200-B and 200-C. The vehicle models 200 are models that simulate the operation of the virtual vehicle according to the driving operation of the driver, in particular, the operation of the accelerator pedal 22, by inputting the driving operation of the driver and the driving condition of battery electric vehicle 100.

Typically, each vehicle model 200 includes a powertrain model that simulates a powertrain of a virtual vehicle. The power train model is a model for reproducing torque output from the power train of the virtual vehicle based on at least an operation of the accelerator pedal 22 input by the driver. Hereinafter, in the present specification, the output torque of the powertrain of the virtual vehicle reproduced by the powertrain model of the virtual vehicle is referred to as virtual torque.

When the target virtual vehicle is an internal combustion locomotive, the powertrain model may include an engine model and a transmission model. The engine model calculates a virtual engine torque (virtual engine torque) output from the engine of the target virtual vehicle based on the operation of the accelerator pedal 22 of the driver. The transmission model outputs a virtual gear ratio (virtual gear ratio) of the target virtual vehicle. In this case, the virtual torque is calculated as the product of the virtual engine torque and the virtual gear ratio.

Each vehicle model 200 also has parameters 201 associated with the behavior of the virtual vehicle. Examples of the parameter 201 include traveling resistance, vehicle weight, wheel diameter, number of gear stages, gear ratio in each gear stage, differential ratio engine maximum torque, and the like.

The base torque calculation unit 121 calculates a torque for reproducing, in battery electric vehicle 100, the output of the powertrain of the target virtual vehicle based on the driver's driving operation. Hereinafter, this torque calculated by the base torque calculation unit 121 is referred to as a base torque in this specification. The base torque is calculated as the product of the virtual torque and the specification absorption coefficient. The specification absorption coefficient is a coefficient for absorbing differences in specifications between the target virtual vehicles and battery electric vehicle 100. An example of a method of calculating the specification absorption coefficient is shown in Equation (c).

The base torque calculation unit 121 acquires information of the target virtual vehicle STV selected by the driver from the mode information acquisition unit 110. Then, the base torque calculation unit 121 refers to the vehicle model database D10 and reads out the vehicle model 200 (target vehicle model) corresponding to the target virtual vehicle STV. The vehicle model 200 read by the base torque calculation unit 121 includes the parameter 201 of the target virtual vehicle. In the embodiment illustrated in FIG. 4, the virtual vehicle B is selected as the target virtual vehicle, and the base torque calculation unit 121 reads the target vehicle model 200-B from the vehicle model database D10.

The base torque calculation unit 121 calculates the virtual torque outputted from the power train of the target virtual vehicle STV in accordance with the driver's manipulation of the accelerator pedal 22 by using the read target vehicle model. More specifically, the base torque calculation unit 121 receives a signal from the sensor system 50. The base torque calculation unit 121 acquires information on the operating state AS (e.g., accelerator operation amount) of the accelerator pedal 22 and information on the traveling state RS (e.g., vehicle speed) of battery electric vehicle 100. Then, the virtual torque output from the powertrain of the target virtual vehicle STV is calculated by simulating the operation of the powertrain of the target virtual vehicle STV by inputting the information to the target vehicle model. In addition, depending on the configuration of the target vehicle model, information such as the operating condition of the brake pedal 24, the steering angle of the steering wheel, and the yaw rate of battery electric vehicle 100 may be inputted to the target vehicle model.

Then, the base torque calculation unit 121 calculates the base torque by multiplying the virtual torque by the specification absorption coefficient. The calculated base torque is transmitted to the target torque calculation unit 123.

The correction torque calculation unit 122 calculates a torque for correcting the difference between battery electric vehicle 100 and the travel resistance of the target virtual vehicles. The correction torque calculation unit 122 first acquires battery electric vehicle 100 and the travel resistance of the target virtual vehicles.

The running resistance acquired herein includes at least a portion of the mechanical losses generated by the configuration of the air resistance, rolling resistance, gradient resistance, acceleration resistance, and power train. The data 105 is stored in the storage device 103 in order to calculate the travel resistance of battery electric vehicle 100. The correction torque calculation unit 122 may use the value stored in the storage device 103 as it is, or may calculate the traveling resistance using the value stored in the storage device 103 and the value acquired in real time by the sensor system 50. The values acquired in real time include, for example, vehicle speed, slope, total vehicle weight, and the like. The values required for the calculation of the running resistance can be determined experimentally in advance by a known method.

For example, ABC method may be used to calculate the traveling resistivity, and the traveling resistivity may be stored in the storage device 103. The traveling resistance may be calculated based on a value stored in advance and the vehicle speed acquired from the vehicle speed sensor 30. In ABC method, the running resistance including the air resistance, the rolling resistance, and the mechanical loss can be calculated. Alternatively, a value necessary for calculating the traveling resistance may be obtained by another method and stored in the storage device 103. Then, the traveling resistance may be calculated based on the value stored in the storage device 103 and the value acquired from the sensor system 50.

A value necessary for calculating the traveling resistance of the target virtual vehicle is included in the parameter 201. Similarly, the value necessary for calculating the traveling resistance of the target virtual vehicle can be obtained experimentally in advance. Alternatively, when the target virtual vehicle is a vehicle that does not actually exist, the target virtual vehicle may be obtained by simulation or the like. The correction torque calculation unit 122 may use the value included in the parameter 201 as it is, or may calculate the traveling resistance using the value included in the parameter 201 and the value acquired in real time by the sensor system 50. For example, the traveling resistance may be calculated using the value included in the parameter 201 and the vehicle speed of battery electric vehicle 100.

In this way, the correction torque calculation unit 122 calculates the traveling resistance generated in battery electric vehicle 100 and the traveling resistance generated when battery electric vehicle 100 is assumed to be the target virtual vehicles. The correction torque calculation unit 122 calculates the correction torque based on the difference between battery electric vehicle 100 and the travel resistances of the target virtual vehicles. The correction torque may be, for example, a difference between the travel resistance conversion torque obtained by converting the travel resistance of battery electric vehicle 100 into the drive wheel torque of battery electric vehicle 100 and the travel resistance conversion torque obtained by converting the travel resistance of the target virtual vehicle into the drive wheel torque of battery electric vehicle 100. Battery electric vehicle 100 running resistance conversion torque and the target virtual vehicle running resistance conversion torque are calculated by the following equations (e), (f), and (g). The calculated correction torque is transmitted to the target torque calculation unit 123.

The target torque calculation unit 123 calculates the target torque based on the base torque calculated by the base torque calculation unit 121 and the correction torque calculated by the correction torque calculation unit 122. For example, as shown in Equation (a), the sum of the base torque and the correction torque may be set as the target torque. Thus, the target torque is calculated, and the electric motor 2 is controlled based on the calculated target torque.

### 6. Effect

As described above, in battery electric vehicle 100 according to the present embodiment, in the on-demand mode, the target torque in which the traveling resistance is taken into account is calculated and the electric motor 2 is controlled. The effect that the target torque is calculated based on the traveling resistance in this manner will be described.

The difference in acceleration characteristics for each vehicle is generally caused by the difference in the configuration of the powertrain from the driving source to the drive wheels. Therefore, as the calculation method of the target torque, it is conceivable to calculate the target torque so as to simply simulate the configuration of the powertrain of the target virtual vehicle as in the calculation method B of FIG. 5.

However, not only the torque output from the powertrain is an element that affects the acceleration characteristics of the target virtual vehicle. Differences in the running resistance of each vehicle also affect the acceleration characteristics. For example, if the virtual vehicle is a vehicle that is heavier than battery electric vehicle 100 and is more resistant to running, the acceleration should be slower. When such a vehicle is selected as the target virtual vehicle, if the torque outputted from the powertrain is reproduced as it is, the acceleration feeling reproduced by battery electric vehicle 100 becomes a faster acceleration feeling than the target virtual vehicle. The driver may feel uncomfortable. In this way, when only the torque output from the powertrain is reproduced without taking the traveling resistance into consideration, there is a possibility that the driver feels uncomfortable. In particular, in a region where the operation amount of the accelerator pedal 22 is small, the influence of the traveling resistance on the change of the acceleration is large, and therefore, there is a possibility that the driver feels a sense of discomfort to be increased.

In contrast, in the present embodiment, the target torque is calculated by considering the difference between battery electric vehicle 100 and the travel resistance of the target virtual vehicle. That is, the on-demand mode torque calculation unit 120 calculates the target torque on the basis of the base torque simulating the power train of the target virtual vehicle and the correction torque for correcting the difference between battery electric vehicle 100 and the travel resistance of the target virtual vehicle. As a result, it is possible to make the acceleration feeling of battery electric vehicle 100 closer to that of the actual target virtual vehicle than to simply set the target torque simulating the powertrain of the virtual vehicle. In this way, the vehicle behavior of the virtual vehicle can be reproduced more accurately, and the degree of satisfaction of the driver who wants to experience the driving feeling of the virtual vehicle can be improved.

### 7. Example of a Virtual Vehicle

The plurality of virtual vehicles may include a transmission vehicle. The virtual vehicle may include a transmission vehicle. In this case, battery electric vehicle 100 may include, in addition to the driving operation member used for driving battery electric vehicle 100, a pseudo-shifting operation member simulating an operation member used for shifting operation of the transmission vehicle.

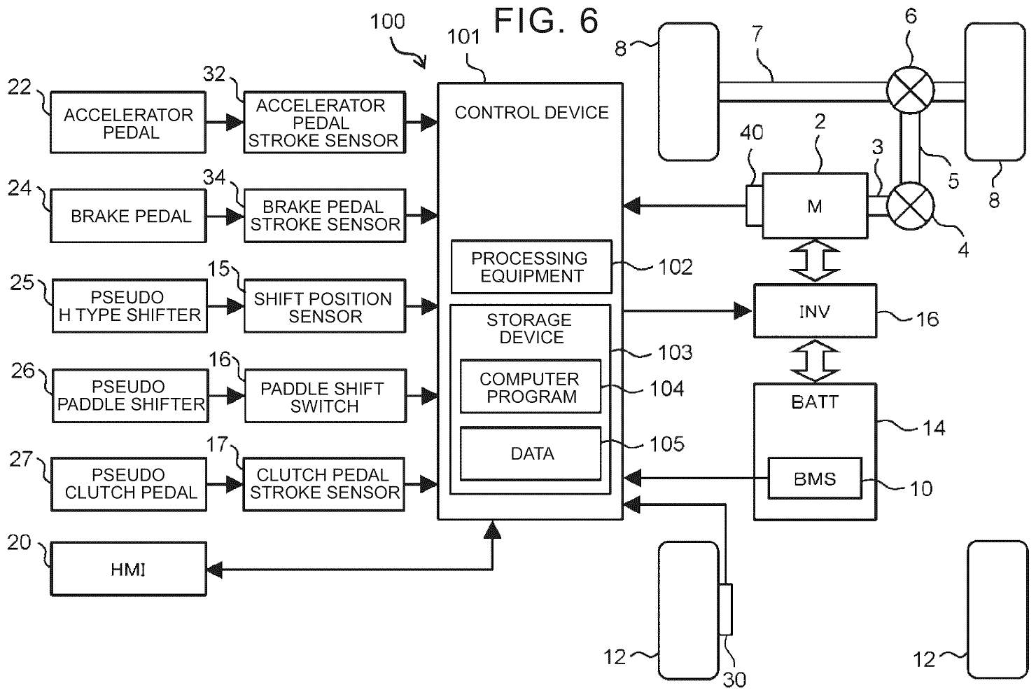

FIG. 6 illustrates an exemplary pseudo-shifting operation member included in battery electric vehicle 100. The pseudo-shifting operation member includes a pseudo-H shifter 25, a pseudo-paddle shifter 26, and a pseudo-clutch pedal 27. The pseudo H-type shifter 25 is an operation member simulating the H-type shifter of the transmission vehicle, and the driver can select the gear stage by operating the shift stick of the pseudo H-type shifter 25. The pseudo-paddle shifter 26 is an operation member that simulates a paddle shifter of a transmission vehicle, and the driver can raise or lower the gear stage by operating the pseudo-paddle shifter 26. The pseudo clutch pedal 27 is an operation member simulating the clutch pedal of the transmission vehicle, and the driver can change the virtual clutch opening in the range of 0% to 100% by operating the pseudo clutch pedal 27.

The pseudo-shifting operation member is provided with a switch for outputting a signal indicating an operating state of the driver. A signal output from each switch and indicating an operation state of the pseudo-shifting operation member may be input to the power train model and used for calculation of the virtual torque. In this way, the motor control device 101a controls the electric motor 2 so as to reproduce the behavior of the transmission vehicles based on the operation of the driving operation member and the pseudo-shifting operation member.

What is claimed is:

1. A battery electric vehicle that includes an electric motor as a driving source, the battery electric vehicle comprising one or more processors that control the electric motor so as to reproduce behavior of a virtual vehicle that is different from the battery electric vehicle, wherein the one or more processors are configured to:
calculate target torque based on a travel resistance of the virtual vehicle; and
control torque of the electric motor based on the target torque.

2. The battery electric vehicle according to claim 1, further comprising a driving operation member that is used to drive the battery electric vehicle, wherein the one or more processors are configured to:
calculate base torque for reproducing torque output from a power train of the virtual vehicle based on an operation of the driving operation member;
calculate correction torque based on the travel resistance of the virtual vehicle; and
calculate the target torque based on the base torque and the correction torque.

3. The battery electric vehicle according to claim 2, wherein the one or more processors are configured to calculate the correction torque based on a difference between a travel resistance of the battery electric vehicle and the travel resistance of the virtual vehicle.

4. The battery electric vehicle according to claim 2, wherein:
the virtual vehicle includes a transmission vehicle;
the battery electric vehicle further includes a pseudo-shifting operation member that simulates an operation member that is used for a shifting operation of the transmission vehicle; and
the one or more processors control the electric motor so as to reproduce behavior of the transmission vehicle based on an operation of the pseudo-shifting operation member.

5. A control method of controlling a battery electric vehicle that includes an electric motor as a driving source, the control method comprising:
acquiring a travel resistance of a virtual vehicle that is different from the battery electric vehicle;
calculating target torque for reproducing behavior of the virtual vehicle based on the travel resistance of the virtual vehicle; and
controlling torque of the electric motor based on the target torque
